(19) United States
(12) Patent Application Publication
(10) Pub. No.: US 2024/0170694 A1
(43) Pub. Date: May 23, 2024

(54) BLOCKING DEVICE FOR RECIRCULATION LOOP IN FUEL CELL STACK

(71) Applicant: Schaeffler Technologies AG & Co. KG, Herzogenaurach (DE)

(72) Inventors: Jan Pfannenmueller, Großhabersdorf (DE); Matthias Reum, Lauf a.d. Pegnitz (DE); Markus Popp, Frensdorf (DE)

(73) Assignee: Schaeffler Technologies AG & Co. KG, Herzogenaurach (DE)

(21) Appl. No.: 18/284,316

(22) PCT Filed: Jan. 12, 2022
(86) PCT No.: PCT/DE2022/100010

§ 371 Date: Sep. 27, 2023

(30) Foreign Application Priority Data
Apr. 7, 2021 (DE) 10 2021 108 649.3

(51) Int. Cl. H01M 8/04089; H01M 8/04223; H01M 8/04746

(52) U.S. Cl. CPC H01M 8/04097; H01M 8/04231; H01M 8/04753

(57) ABSTRACT

A blocking device for a recirculation loop in a fuel cell stack comprises a hydrogen inlet and a recirculation gas inlet. In order to obtain an inexpensive blocking device for the recirculation loop, a recirculation loop blocking valve is provided, which is switched by an upstream hydrogen switching valve.

### CROSS-REFERENCE TO RELATED APPLICATIONS

This application is the U.S. National Phase of PCT Appln. No. PCT/DE2022/100010 filed Jan. 12, 2022, which claims priority to DE 102021108649.3 filed Apr. 7, 2021, the entire disclosures of which are incorporated by reference herein.

### TECHNICAL FIELD

The disclosure relates to a blocking device for the recirculation loop in a fuel cell stack, comprising a hydrogen inlet and a recirculation gas inlet.

### BACKGROUND

Fuel cells convert chemical energy of a fuel into electricity through a reaction with oxygen (usually from the air). The most commonly used fuel is hydrogen. Therefore, in the following, “hydrogen” will always be used to refer to the fuel, but this explicitly includes other gaseous fuels such as butane, propane, methane, methanol or other hydrocarbons.

Low-temperature fuel cells are known which have an ion-conducting polymer electrolyte separating an anode from a cathode. The hydrogen is fed to the anode compartment, the oxygen to the cathode compartment. The hydrogen ions travel through the electrolyte, while the electrons travel through an electrical circuit and a consumer outside of the cell. Such PEM fuel cells are also referred to as polymer electrolyte fuel cells (PEFCs), proton exchange membrane fuel cells (PEMFCs), or solid polymer fuel cells (SPFCs). Since a fuel cell normally generates a voltage of only approx. 1 V, several cells are usually connected to form what are termed stacks in order to achieve a higher overall voltage.

During operation, hydrogen fuel cells are supplied with hydrogen super stoichiometrically, which means that they do not consume all the hydrogen in the anode compartment, as otherwise liquid water and inert gases would accumulate. In order not to waste the excess hydrogen, it is recycled, i.e., fed into a recirculation system. For this purpose, a recirculation loop is provided, which withdraws the hydrogen from the anode compartment and brings it to a mixing device, in which it is mixed with fresh hydrogen and then fed back to the anode compartment. For this purpose, there exists the possibility of actively circulating the hydrogen with a mechanical pump or a blower. This is shown, for example, in WO 2012/104 191 A1.

It is also possible to circulate the hydrogen passively by providing a jet pump with a nozzle for the fresh hydrogen, which carries the hydrogen to be recycled along with the higher fresh hydrogen pressure. Such a hydrogen supply with passive recirculation is shown in US 2014/008 0016 A1, comprising a hydrogen inlet, a recirculation gas inlet, a jet pump with a hydrogen control valve for the hydrogen, a mixing unit and a blocking device for the recirculation line. This blocking device for the recirculation loop of a fuel cell stack comprising a hydrogen inlet and a recirculation gas inlet forms the preamble of claim 1.

In some operating situations it is necessary or desirable to prevent the return of the recirculation loop. Furthermore, over the course of operation the recirculation gas accumulates nitrogen and other undesirable gases, which have to be vented depending on the operating strategy. This is done via a purge valve. When purging takes place, it is advantageous if recirculation is prevented.

Since the recirculation loop works at a relatively low overpressure, the cross-sections of the lines are relatively large. The flow should also not be severely restricted in the open position. However, large, low-resistance blocking valves are very expensive.

### SUMMARY

The present disclosure provides a less expensive blocking device for the recirculation loop of a hydrogen supply of a fuel cell stack.

According to an exemplary embodiment of the present disclosure, a blocking device for the recirculation loop of a fuel cell stack is provided, comprising a hydrogen inlet and a recirculation gas inlet, in which a recirculation loop blocking valve is provided, which is switched by an upstream hydrogen switching valve.

According to the present disclosure, the recirculation loop blocking valve is controlled by high hydrogen pressure in a reservoir (currently approx. 900 bar), wherein the hydrogen supply pressure then actuates a valve slide of the recirculation loop blocking valve. The hydrogen pressure can also be significantly lower. Some operators work at approximately 25 bar medium hydrogen pressure. The blocking valve, which has a significantly larger diameter, is not then moved according to the present disclosure by an electrical actuator, i.e., an auxiliary force, but is, as it were, triggered and opened by another force. Here the inventors use the energy that is already available in the stored fresh hydrogen or as pressure energy and is available on site. After all, the relatively high pressure (force per area) of the hydrogen reservoir exerts a relatively high force when it strikes a piston (area) and thus also moves large pistons or slides safely and reliably.

To utilize the hydrogen pressure, according to the present disclosure a second valve, referred to here as a hydrogen switching valve, is connected upstream of the recirculation loop blocking valve. The hydrogen switching valve can then be relatively small and can be moved by a small actuator. This upstream valve then switches the hydrogen pressure to the recirculation loop blocking valve. Since the hydrogen supply pressure is significantly greater than the pressure in the recirculation loop of the stack, the valve slide of the recirculation loop blocking valve moves to the “recirculation loop closed” valve position due to the pressure differences. The recirculation loop blocking valve then completely closes the recirculation loop, but it is still possible to supply the stack with fresh hydrogen at the same time and thus continue operation. The hydrogen switching valve also has the advantage that only static seals are required to the outside. This means that it only has inexpensive, proven sealing elements and does not need any more expensive elements that would also seal during rotation.

In embodiments, the upstream hydrogen switching valve is an inherently common controlled valve that opens or closes an opening. The recirculation loop blocking valve, on the other hand, is a slide valve whose valve piston can partially or completely close the somewhat larger line during its movement. The slide or piston may move transversely to the line to be opened and closed.

The stroke and cross-section of the two valves can be freely selected over a wide range. It is favorable if the valve stroke of the recirculation loop blocking valve is independent of the valve stroke or armature stroke of the hydrogen switching valve. Since this, as it were, only provides the impetus for the movement of the recirculation loop blocking valve, a small valve stroke is sufficient to allow the higher hydrogen reservoir pressure to act on the recirculation loop blocking valve, which can then move it further at a much larger stroke.

The switched cross-section of the recirculation loop blocking valve is also independent of the cross-section of the hydrogen switching valve. Even a small bore switching valve can allow the high hydrogen pressure to reach the large bore recirculation loop blocking valve and cause it to move. The cross-section or the bore of the recirculation loop blocking valve can be chosen freely and is dependent, for example, on the prevailing pressure conditions between the hydrogen supply pressure and the recirculation loop pressure in/on the stack.

The hydrogen switching valve can be controlled in a known manner, for example pneumatically, hydraulically or mechanically. As an example, the control can be electrical or electromagnetic, for example via a solenoid valve with an armature in a plunger coil.

It is possible that the piston of the valve moved by an actuator is actively pushed both in one direction and in the opposite direction, for example moved by a current in one direction and by an opposite current in the other direction. In embodiments, the hydrogen switching valve and/or the recirculation loop blocking valve each have a restoring mechanism, for example each have an integrated restoring spring. This restoring component then causes a movement in the opposite direction. The restoring element or springs can move the one or both valves into what is termed the fail-safe position. This means that, for example, the restoring spring of the hydrogen switching valve pushes it into the closed position, so that in the event of a power failure or another malfunction in the control system, the hydrogen switching valve is closed, leaving the downstream recirculation loop blocking valve open and thus keeping the normal recirculation loop open. This also means that, for example, the restoring spring of the recirculation loop blocking valve pushes it into the open position, so that in the event of a power failure or another malfunction in the control system, the recirculation loop blocking valve is open, i.e., the normal recirculation loop remains open. This is achieved via the two springs.

Two valves are used in the present disclosure. One is the hydrogen switching valve, which is actuated, and the other is the recirculation loop blocking valve, which is then pushed into the closed position by the high-pressure gas flow. It is advisable to provide a mechanism that allows the second valve to slide back into its original position after a certain time. This can be a small bore that releases gas pressure after the first valve closes, allowing the second valve, the recirculation loop blocking valve, to return to its normal position after a certain period of time. In embodiments, the valve slide of the recirculation loop blocking valve has a certain amount of leakage, that is, its valve slide does not seal completely against the housing, thus allowing the introduced gas to escape, so that the valve slide moves back automatically, for example via its restoring spring. Without this leakage, no pressure equalization would take place. This can be done by increased radial guide play and/or by a bore and/or by a relief groove.

If the fuel cell is intended to drive a vehicle, the hydrogen must be carried along with it and stored in a type of tank. For this purpose, it is stored either in liquid form or under pressure. Since extremely low temperatures (maximum of a few Kelvin) are required for liquid storage, storage under pressure (up to approx. 900 bar) has currently become established. This requires valves that are also designed for this high pressure range. Strong adjusting elements or actuators are often necessary here in order to carry out movements against these pressures. In embodiments of the present disclosre, a hydrogen switching valve is therefore used which has pressure compensation for the valve piston (or the armature in the case of solenoid valves) and thus significantly reduces the adjusting forces. This therefore means that lighter and weaker actuators can be used. In embodiments of the present disclosure, one or more overflow bores are therefore provided in the housing and/or in the actuator, which allow the hydrogen to reach the other side of the valve piston and thus only require a lower adjusting force. It is also possible to provide one or more longitudinal grooves in the piston or armature. Pressure compensation in the armature end stop is particularly useful.

In order to be able to reliably and completely fulfill the blocking function against the very high hydrogen pressure, provision can be made for the hydrogen switching valve to be assigned a sealing valve seat. For example, a seat valve can be provided in the front stop of the actuator. The seat can be a ball seat or a flat valve face. Sealing elements can also be provided, such as one or more O-rings, overmolded seats or an overmolded valve slide.

The blocking device according to the present disclosure can be designed as an independent structural unit, which is then attached to, or near to, the gas inlet to the stack, i.e., for example at the entrance to the anode compartment of the stack, where the fresh hydrogen supply and the recirculation gas line come together. However, it is also possible and within the scope of the present disclosure for the hydrogen switching valve and the recirculation loop blocking valve to form a structural unit together with a hydrogen injection device. For example, the present disclosure described here can be integrated with a hydrogen injection device with passive recirculation, which is equipped with a hydrogen inlet, a recirculation gas inlet, a jet pump with a nozzle and nozzle needle for the hydrogen, a mixing unit, and a linear actuator for moving a valve piston with the nozzle needle. In this device, a hydrogen control valve can also be integrated on the nozzle needle, which can simultaneously act as a hydrogen pressure control valve and as a blocking valve.

However, the present disclosure can also be used in fuel cell stacks with active recirculation.

In embodiments, the recirculation loop blocking valve has end position damping for one or both end positions of both stroke directions. This can be an elastic element such as a rubber washer. Pneumatic end position damping can be provided. A piston (here, for example, the cylindrical guide of the return spring) moves into a blind hole. Depending on the clearance set between the bore and the piston, counter-pressure builds up as the piston enters the bore and thus slows down the movement.

The blocking device according to the present disclosure can be made of any suitable material. The material must be able to withstand the mechanical loads and temperatures prevailing there. Thus, metal or plastic is recommended as the predominant material for the pistons, housing and lines. Elastic materials are recommended for the seals.

### BRIEF DESCRIPTION OF THE DRAWINGS

In the following, the preset disclosure is explained by way of example with reference to the accompanying drawings using exemplary embodiments, wherein the features presented below can present an aspect of the present disclosure both individually and in combination. In the figures:

FIG. 1: shows a blocking device according to the present disclosure,

FIG. 2: shows a detail from FIG. 1, and

FIGS. 3 to 6: show the blocking device of FIG. 1 in four different switching states.

### DETAILED DESCRIPTION

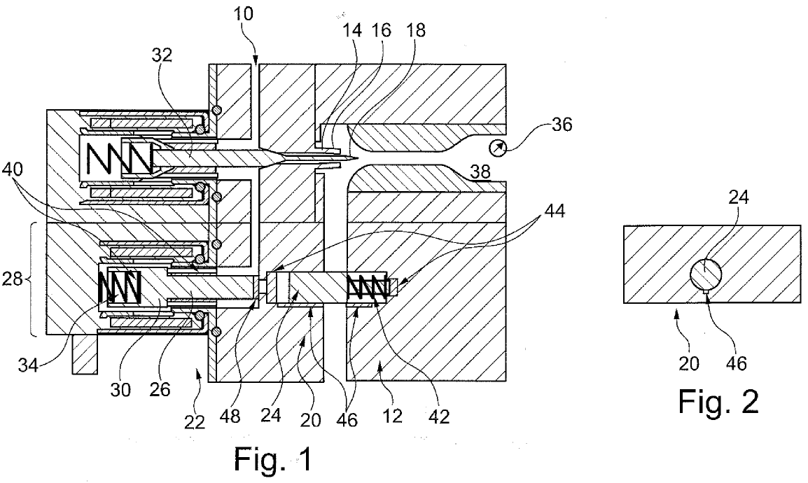

FIG. 1 shows a blocking device according to the present disclosure on a hydrogen injection device for a fuel cell stack with a passive recirculation unit. The hydrogen injection device comprises a hydrogen inlet 10, a recirculation gas inlet 12, and a jet pump 14 with a nozzle 16 and nozzle needle 18, which injects fresh hydrogen from the hydrogen inlet 10 via the nozzle 16. This hydrogen, which is under high pressure and is therefore fast, carries recirculation gas from the recirculation gas inlet 12 to the jet pump 14 in the direction of the gas outlet 38 to an anode compartment of the stack, as a result of which the passive recirculation is kept going. The gases mix in a suction chamber in front of the nozzle 16 and reach the gas outlet 38 through a mixing tube and a diffuser. A hydrogen control valve 32 is moved back and forth by a linear actuator with an electromagnet and thus controls the amount of fresh hydrogen supplied. A pressure sensor 36 measures the gas pressure in the anode compartment and thus provides a measure of the amount of hydrogen required.

Below the hydrogen injection device, but integrated here in the same housing, are the essential components of the blocking device according to the present disclosure, namely a hydrogen switching valve 22, with a valve piston or valve slide 26, and a recirculation loop blocking valve 20 with a valve piston or valve slide 24.

The hydrogen switching valve 22 is equipped with a linear actuator 28, for example an electromagnet, which can thus move the valve slide 26 back and forth via an armature 30. The valve slide 26 of the hydrogen switching valve 22 is pressed to the right by a restoring spring 34 into the right-hand stop and, with its valve seat 48, closes an opening there that leads from the hydrogen inlet 10 to the recirculation loop blocking valve 20 (normally closed position). In the hydrogen switching valve 22, next to the valve slide 26, there are two overflow bores 40 which ensure pressure compensation, in particular in the armature end stop.

To the right of said opening is the recirculation loop blocking valve 20, the valve slide 24 of which is pushed to the left by a restoring spring 42. In this left-hand stop position, the line from the recirculation gas inlet 12 to the stack would be released, which leads to an open position for normal operation (normally open position). In FIG. 1, the valve slide 24 of the recirculation loop blocking valve 20 is not shown in one of its two end positions, but in an intermediate position in which the valve slide 24 of the recirculation loop blocking valve 20 closes off the recirculation gas inlet 12 from the stack. For the valve slide 24 of the recirculation loop blocking valve 20, two end position dampers 44 are provided at the end stops, which can work pneumatically. Below the bore for the valve slide 24 of the recirculation loop blocking valve 20 are two longitudinal grooves 46, which allow gas to flow slowly past the valve slide 24 and serve as overflow bores.

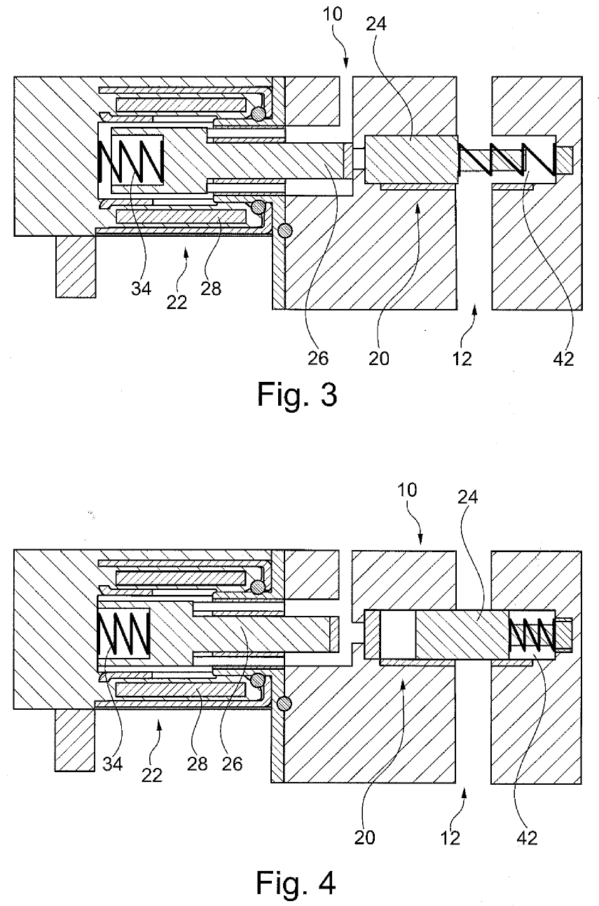

FIG. 2 again shows the valve slide 24 of the recirculation loop blocking valve 20, here in a plan view with the longitudinal groove 46 in the housing. It can also be seen here that gas can flow past the valve slide 24 of the recirculation loop blocking valve 20 and can create a pressure equalization in front of and behind it, so that the valve slide 24 becomes force-free and the return spring 42 can easily push it into the open position for normal operation.

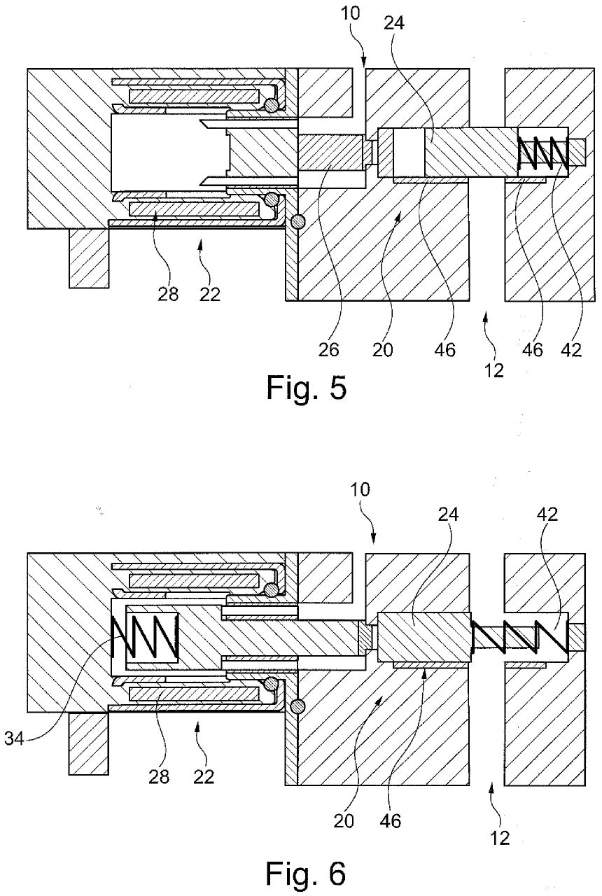

FIGS. 3 to 6 show the blocking device of FIG. 1 in four different switching states in order to explain the mode of operation.

FIG. 3 shows the fail-safe position of the two valves, the hydrogen switching valve 22 and the recirculation loop blocking valve 20, i.e., the rest position when everything is de-energized. Since the linear actuator 28 is not working, the restoring spring 34 presses the valve slide 26 of the hydrogen switching valve 22 into the right-hand end position, where the valve slide 26 closes the opening to the recirculation loop blocking valve 20. The hydrogen switching valve 22 is therefore closed. The high-pressure hydrogen gas cannot then reach the recirculation loop blocking valve 20 from the hydrogen inlet 10.

The second restoring spring 42 presses the valve slide 24 of the recirculation loop blocking valve 20 into the left-hand end position, so that the valve slide 24 leaves the recirculation loop open. The recirculation loop blocking valve 20 is therefore open. The recirculation gas can thus reach upwards from the recirculation gas inlet 12 to the hydrogen injection device and thus to the stack.

FIG. 4 shows the two valves, the hydrogen switching valve 22 and the recirculation loop blocking valve 20, in a different position. The linear actuator 28 is now energized and pulls the valve slide 26 of the hydrogen switching valve 22 against the action of the spring 34 slightly to the left, so that the valve slide 26 opens the opening to the recirculation loop blocking valve 20. The hydrogen switching valve 22 is therefore open. The high-pressure hydrogen gas can thus reach the recirculation loop blocking valve 20 from the hydrogen inlet 10.

This high-pressure gas (or the hydrogen supply pressure) pushes the valve slide 24 of the recirculation blocking valve 20 to the right against the action of the spring 42, so that the valve slide 24 closes the recirculation loop. The recirculation loop blocking valve 20 is therefore closed. The recirculation gas can no longer reach upwards from the recirculation gas inlet 12 to the hydrogen injection device and thus to the stack.

FIG. 5 again shows the two valves, the hydrogen switching valve 22 and the recirculation loop blocking valve 20, in a further position. The linear actuator 28 is now de-energized, as a result of which the valve slide 26 of the hydrogen switching valve 22 is spring-loaded to the right back into the right-hand end position, so that the valve slide 26 closes the opening to the recirculation loop blocking valve 20. The hydrogen switching valve 22 is therefore closed. Fresh, high-pressure hydrogen gas cannot reach the recirculation loop blocking valve 20 from the hydrogen inlet 10.

The valve slide 24 of the recirculation blocking valve 20 is located somewhat to the right because of the gas still on its left side, i.e., in the position as in FIG. 4, so that the valve slide 24 still closes the recirculation loop. The recirculation loop blocking valve 20 is therefore closed again. The recirculation gas can still no longer reach upwards from the recirculation gas inlet 12 to the hydrogen injection device and thus to the stack. However, the hydrogen supply pressure in the space to the left of the valve slide 24 of the recirculation blocking valve 20 slowly decreases thanks to the longitudinal groove 46, so that the spring 42 can begin to slowly push the valve slide 24 to the left and thus open the recirculation line.

In FIG. 6 this has now taken place. The linear actuator 28 is still de-energized, as a result of which the spring 34 holds the valve slide 26 of the hydrogen switching valve 22 on the right in the right-hand end position, so that the valve slide 26 closes the opening to the recirculation loop blocking valve 20. The hydrogen switching valve 22 is therefore closed. Fresh, high-pressure hydrogen gas cannot reach the recirculation loop blocking valve 20 from the hydrogen inlet 10.

The hydrogen pressure on the left-hand side of the valve slide 24 of the recirculation blocking valve 20 has now completely dissipated since the gas has escaped via the groove 46 into the recirculation gas line. The spring 42 has succeeded in pushing the valve slide 24 of the recirculation blocking valve 20 all the way to the left, into the open position of the recirculation blocking valve 20. The recirculation gas can thus now reach upwards from the recirculation gas inlet 12 to the hydrogen injection device once more and thus to the stack.

### LIST OF REFERENCE SYMBOLS

10 Hydrogen inlet
12 Recirculation gas inlet
14 Jet pump
16 Nozzle
18 Nozzle needle
20 Recirculation loop blocking valve
22 Hydrogen switching valve
24 Valve slide of the recirculation loop blocking valve
26 Valve slide of the hydrogen switching valve
28 Linear actuator
30 Armature
32 Hydrogen control valve
34 Restoring spring of the hydrogen switching valve
36 Pressure sensor
38 Gas outlet to the stack
40 Overflow bore
42 Restoring spring of the recirculation loop blocking valve
44 End position damping
46 Longitudinal groove
48 Valve seat

1. A blocking device for a recirculation loop of a fuel cell stack, comprising a hydrogen inlet and a recirculation gas inlet, wherein a recirculation loop blocking valve is provided, which is switched by an upstream hydrogen switching valve.

2. The blocking device according to claim 1, wherein the hydrogen switching valve is a slide valve.

3. The blocking device according to claim 1, wherein the hydrogen switching valve is controlled electrically.

4. The blocking device according to claim 1, wherein at least one of the hydrogen switching valve and the recirculation loop blocking valve have a restoring mechanism.

5. The blocking device according to claim 1, wherein the valve slide of the recirculation loop blocking valve is configured to a predetermined amount of leakage.

6. The blocking device according to claim 1, wherein the hydrogen switching valve is pressure compensated.

7. The blocking device according to claim 1, wherein the hydrogen switching valve is designed as a seat valve.

8. The blocking device according to claim 1, wherein the hydrogen switching valve and the recirculation loop blocking valve form a structural unit together with a hydrogen injection device including a hydrogen control valve.

9. The blocking device according to claim 1, wherein the recirculation loop blocking valve has pneumatic end position damping for at least one end position.

10. The blocking device according to claim 1, wherein the blocking device is substantially made of metal or plastic.

11. A blocking device for a recirculation loop in a fuel cell stack comprising:
an inlet;
a recirculation line in communication with the inlet;
a recirculation loop blocking valve arranged in the recirculation line; and
a switching valve arranged between the inlet and the recirculation loop blocking valve, the switching valve being configured to selectively permit communication from the inlet to the recirculation loop blocking valve.

12. The blocking device according to claim 11, further comprising an actuator engaged with the switching valve, the actuator being configured to actuate the switching valve between an open position and a closed position.

13. The blocking device according to claim 11, wherein the switching valve is moveable between an open position and a closed position, wherein the switching valve prevents communication between the inlet and the recirculation loop blocking valve in the closed position and permits communication between the inlet and the recirculation loop blocking valve in the open position.

14. The blocking device according to claim 13, wherein the recirculation loop blocking valve is moveable between an open position and a closed position, wherein the recirculation loop blocking valve prevents communication through the recirculation line in the closed position and permits communication through the recirculation line in the open position.

15. The blocking device according to claim 14, wherein the recirculation loop blocking valve is configured to move to the closed position in response to a gas pressure from the inlet when the switching valve is in an open position.

16. The blocking device according to claim 14, wherein the recirculation loop blocking valve includes a resilient element configured to bias the recirculation loop blocking valve to the open position.

17. The blocking device according to claim 13, wherein the switching valve includes a resilient element configured to bias the switching valve to the closed position.

18. The blocking device according to claim 11, further comprising a groove arranged adjacent to the recirculation loop blocking valve, the groove being configured to permit communication from one axial side of the recirculation blocking valve to the recirculation line.

19. The blocking device according to claim 11, wherein the switching valve is a slide valve.

20. The blocking device according to claim 11, wherein the recirculation blocking valve is a slide valve.
